(19) United States
(12) Patent Application Publication
(10) Pub. No.: US 2014/0220426 A1
(43) Pub. Date: Aug. 7, 2014

(54) PHOSPHORUS CONTAINING COMPOUND, METHOD OF PREPARING SAME, AND ELECTROLYTE FOR RECHARGEABLE LITHIUM BATTERY AND RECHARGEABLE LITHIUM BATTERY INCLUDING THE SAME

(71) Applicant: Samsung SDI Co., Ltd., Yongin-si (KR)

(72) Inventors: Denis Chernyshov, Yongin-si (KR); Woo-Cheol Shin, Yongin-si (KR); Vladimir Egorov, Yongin-si (KR); Pavel Alexandrovich Shatunov, Yongin-si (KR); Alexey Tereshchenko, Yongin-si (KR); Makhmut Khasanov, Yongin-si (KR); Jung-Yi Yu, Yongin-si (KR); Sang-IL Han, Yongin-si (KR); Sang-Hoon Kim, Yongin-si (KR); Duck-Hyun Kim, Yongin-si (KR); Myung-Hwan Jeong, Yongin-si (KR); Seung-Tae Lee, Yongin-si (KR); Tae-Hyun Bae, Yongin-si (KR); Mi-Hyun Lee, Yongin-si (KR); Eon-Mi Lee, Yongin-si (KR); Ha-Rim Lee, Yongin-si (KR); Moon-Sung Kim, Yongin-si (KR); In-Haeng Cho, Yongin-si (KR); E-Rang Cho, Yongin-si (KR); Dong-Myung Choi, Yongin-si (KR)

(73) Assignee: Samsung SDI Co., Ltd., Yongin-si (KR)

(21) Appl. No.: 14/011,745

(22) Filed: Aug. 27, 2013

Related U.S. Application Data
(60) Provisional application No. 61/761,638, filed on Feb. 6, 2013.

(51) Int. Cl. H01M 10/0567; H01M 10/0525

(52) U.S. Cl. CPC H01M 10/0567; H01M 10/0525
USPC 429/188; 558/199

(57) ABSTRACT

A phosphorous containing compound represented by the following Chemical Formula 1, a method of preparing the phosphorous containing compound, an electrolyte for a rechargeable lithium battery including the phosphorous containing compound, and a rechargeable lithium battery including the electrolyte.

(R¹O)₂P(NR²R³). [Chemical Formula 1]

### CROSS-REFERENCE TO RELATED APPLICATION

This application claims priority to and the benefit of U.S. Provisional Application No. 61/761,638, filed on Feb. 6, 2013 in the U.S. Patent and Trademark Office, the entire content of which is incorporated herein by reference.

### BACKGROUND

1. Field

This disclosure relates to a phosphorous containing compound, a method of preparing the same, and an electrolyte for a rechargeable lithium battery and a rechargeable lithium battery including the same.

2. Description of the Related Art

Due to recent reductions in size and weight of portable electronic equipment, there has been a need to develop rechargeable lithium batteries for such portable electronic equipment having both high performance and large capacity.

Rechargeable lithium batteries are manufactured by injecting an electrolyte into a battery cell, which includes a positive electrode including a positive active material capable of intercalating/deintercalating lithium ions and a negative electrode including a negative active material capable of intercalating/deintercalating lithium ions.

The electrolyte includes an organic solvent and a lithium salt dissolved therein, which plays a role of determining stability and performance of the rechargeable lithium battery. In particular, the electrolyte is more important for stability of a high voltage rechargeable lithium battery.

### SUMMARY

Aspects of embodiments of the present disclosure are directed toward a phosphorous containing compound.

Aspects of embodiments of the present disclosure are also directed toward a method of preparing the phosphorous containing compound.

Aspects of embodiments of the present disclosure are also directed toward an electrolyte for a rechargeable lithium battery having an excellent cycle-life characteristic and high-rate charge and discharge characteristics at a high voltage and a high temperature, including the phosphorous containing compound.

Aspects of embodiments of the present disclosure are also directed toward a rechargeable lithium battery including the electrolyte for a rechargeable lithium battery.

According to an embodiment, a phosphorous containing compound is provided, which is represented by the following Chemical Formula 1:

(R¹O)₂P(NR²R³) [Chemical Formula 1]

wherein:

R¹ to R³ are each independently selected from hydrogen, a substituted or unsubstituted C1 to C20 alkyl group, a substituted or unsubstituted C1 to C20 haloalkyl group, a substituted or unsubstituted C2 to C20 alkenyl group, a substituted or unsubstituted C2 to C20 haloalkenyl group, a substituted or unsubstituted C2 to C20 alkynyl group, a substituted or unsubstituted C2 to C20 haloalkynyl group, a substituted or unsubstituted C1 to C20 alkoxy group, a substituted or unsubstituted C1 to C20 haloalkoxy group, a substituted or unsubstituted C6 to C30 aryl group, a substituted or unsubstituted C6 to C30 haloaryl group, —C—O—R⁴, and —O—C—O—R⁵;

each of two R¹ is the same or different from each other;

R⁴ and R⁵ are independently selected from a substituted or unsubstituted C1 to C20 alkyl group, a substituted or unsubstituted C1 to C20 haloalkyl group, a substituted or unsubstituted C6 to C30 aryl group, and a substituted or unsubstituted C6 to C30 haloaryl group.

In one embodiment, at least one of R¹ to R³ is selected from the substituted or unsubstituted C1 to C20 haloalkyl group, the substituted or unsubstituted C2 to C20 haloalkenyl group, the substituted or unsubstituted C2 to C20 haloalkynyl group, the substituted or unsubstituted C1 to C20 haloalkoxy group, and the substituted or unsubstituted C6 to C30 haloaryl group.

In one embodiment, at least one of R¹ to R³ is selected from a substituted or unsubstituted C1 to C20 fluoroalkyl group, a substituted or unsubstituted C2 to C20 fluoroalkenyl group, a substituted or unsubstituted C2 to C20 fluoroalkynyl group, a substituted or unsubstituted C1 to C20 fluoroalkoxy group, and a substituted or unsubstituted C6 to C30 fluoroaryl group.

In one embodiment, at least one of R¹ to R³ is a substituted or unsubstituted C1 to C20 fluoroalkyl group.

In one embodiment, the phosphorous containing compound is represented by the following Chemical Formula 2:

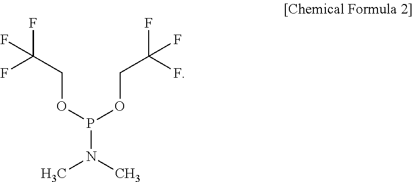 [SMILES: CN(C)P(OCC(F)(F)F)OCC(F)(F)F]

According to a further embodiment, a rechargeable lithium battery electrolyte including the phosphorous containing compound is provided.

In one embodiment, the phosphorous containing compound is in an amount of from 0.1 to 5 wt % based on a total amount of the electrolyte.

In one embodiment, the rechargeable lithium battery electrolyte further includes a lithium salt and a non-aqueous organic solvent.

According to a further embodiment, a rechargeable lithium battery including the rechargeable lithium battery electrolyte is provided. In one embodiment, the rechargeable lithium battery includes a positive electrode, a negative electrode, and the electrolyte.

In one of these embodiments, in Chemical Formula 1, at least one of R¹ to R³ is selected from a substituted or unsubstituted C1 to C20 fluoroalkyl group, a substituted or unsubstituted C2 to C20 fluoroalkenyl group, a substituted or unsubstituted C2 to C20 fluoroalkynyl group, a substituted or unsubstituted C1 to C20 fluoroalkoxy group, and a substituted or unsubstituted C6 to C30 fluoroaryl group.

In another one of these embodiments, in Chemical Formula 1, at least one of R¹ to R³ is a substituted or unsubstituted C1 to C20 fluoroalkyl group.

In another one of these embodiments, the phosphorous containing compound is represented by the following Chemical Formula 2:

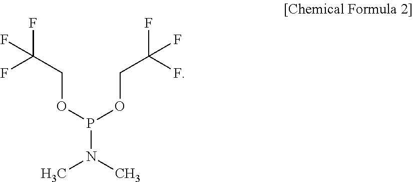 [SMILES: CN(C)P(OCC(F)(F)F)OCC(F)(F)F]

According to a further embodiment, a method of preparing the phosphorous containing compound is provided. The method includes reacting a compound represented by the following Chemical Formula 3:

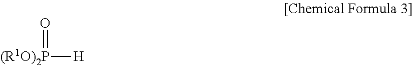

with phosphorous chloride to provide a compound represented by the following Chemical Formula 4:

(R¹O)₂PCl; [Chemical Formula 4]
and reacting an amine compound represented by the following Chemical Formula 5:

R²R³NH [Chemical Formula 5]
with the compound represented by Chemical Formula 4 to provide the phosphorous containing compound represented by Chemical Formula 1.

In one embodiment, the reacting of the compound represented by Chemical Formula 3 with phosphorous chloride is in chlorinated solvent.

In one embodiment, the reacting of the amine compound represented by Chemical Formula 5 with the compound represented by Chemical Formula 4, is in chlorinated solvent.

In one embodiment, the reacting of the compound represented by Chemical Formula 4 with the amine compound represented by Chemical Formula 5 is for 2 to 24 hours.

In one embodiment, a molar ratio of the amine compound represented by Chemical Formula 5 to the compound represented by Chemical Formula 4, is from 2:1 to 4:1.

In one embodiment, the compound represented by Chemical Formula 3 is

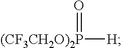

and the compound represented by Chemical Formula 4 is (CF₃CH₂O)₂PCl.

In one embodiment, the amine compound represented by Chemical Formula 5 is NH(CH₃)₂; and the phosphorous containing compound represented by Chemical Formula 1 is

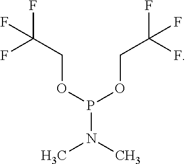 [SMILES: CN(C)P(OCC(F)(F)F)OCC(F)(F)F]

Other embodiments will be described in the detailed description.

A rechargeable lithium battery according to some embodiments has an excellent cycle-life characteristic and/or high-rate charge and discharge characteristics at a high voltage and/or a high temperature.

### BRIEF DESCRIPTION OF THE DRAWINGS

The accompanying drawings, together with the specification, illustrate embodiments of the present invention, and, together with the description, serve to explain the principles of the present invention.

FIG. 1 is a schematic view showing a rechargeable lithium battery according to one embodiment.

FIG. 2 is an LSV (linear sweep voltametry) graph of electrolytes for a rechargeable lithium battery according to Example 1 and Comparative Example 1.

FIG. 3 is a graph showing capacities of rechargeable lithium battery cells according to Example 1 and Comparative Example 1 as a function of cycle.

### DETAILED DESCRIPTION

In the following detailed description, only certain embodiments of the present invention are shown and described, by way of illustration. As those skilled in the art would recognize, the invention may be embodied in many different forms and should not be construed as being limited to the embodiments set forth herein.

Also, in the context of the present application, when a first element is referred to as being “on” a second element, it can be directly on the second element or be indirectly on the second element with one or more intervening elements interposed therebetween. Like reference numerals designate like elements throughout the specification

As used herein and according to embodiments of the present invention, when a definition is not otherwise provided, the term ‘substituted’ refers to, for example, substitution of a hydrogen in a compound with a substituent selected from a halogen (F, Br, Cl, or I), a hydroxyl group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 hetero arylalkyl group, a C3 to C30 cycloalkyl group, a C3 to C15 cycloalkenyl group, a C6 to C15 cycloalkynyl group, a C2 to C20 heterocycloalkyl group, and a combination thereof.

In an embodiment a phosphorus containing compound represented by the following Chemical Formula 1 is provided:

(R¹O)₂P(NR²R³). [Chemical Formula 1]

In the above Chemical Formula 1, R¹ to R³ are each independently selected from hydrogen, a substituted or unsubstituted C1 to C20 alkyl group, a substituted or unsubstituted C1 to C20 haloalkyl group, a substituted or unsubstituted C2 to C20 alkenyl group, a substituted or unsubstituted C2 to C20 haloalkenyl group, a substituted or unsubstituted C2 to C20 alkynyl group, a substituted or unsubstituted C2 to C20 haloalkynyl group, a substituted or unsubstituted C1 to C20 alkoxy group, a substituted or unsubstituted C1 to C20 haloalkoxy group, a substituted or unsubstituted C6 to C30 aryl group, a substituted or unsubstituted C6 to C30 haloaryl group, —C—O—R⁴, and —O—C—O—R⁵. Here, R⁴ and R⁵ are each independently selected from a substituted or unsubstituted C1 to C20 alkyl group, a substituted or unsubstituted C1 to C20 haloalkyl group, a substituted or unsubstituted C6 to C30 aryl group, and a substituted or unsubstituted C6 to C30 haloaryl group. Here, each of two R¹ is the same or different from each other.

In one embodiment, at least one of R¹ to R³ is selected from the substituted or unsubstituted C1 to C20 haloalkyl group, the substituted or unsubstituted C2 to C20 haloalkenyl group, the substituted or unsubstituted C2 to C20 haloalkynyl group, the substituted or unsubstituted C1 to C20 haloalkoxy group, and the substituted or unsubstituted C6 to C30 haloaryl group.

In one embodiment, at least one of R¹ to R³ is selected from a substituted or unsubstituted C1 to C20 fluoroalkyl group, a substituted or unsubstituted C2 to C20 fluoroalkenyl group, a substituted or unsubstituted C2 to C20 fluoroalkynyl group, a substituted or unsubstituted C1 to C20 fluoroalkoxy group, and a substituted or unsubstituted C6 to C30 fluoroaryl group.

In one embodiment, at least one of R¹ to R³ is selected from a substituted or unsubstituted C1 to C20 fluoroalkyl group.

In one embodiment, the phosphorus containing compound represented by Chemical Formula 1 is a compound represented by the following Chemical Formula 2 but embodiments of the present disclosure are not limited thereto:

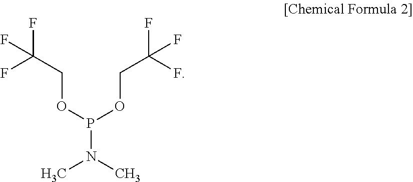 [SMILES: CN(C)P(OCC(F)(F)F)OCC(F)(F)F]

According to a further embodiment, a method of preparing the phosphorus containing compound represented by Chemical Formula 1 is provided. The method includes reacting a compound represented by the following Chemical Formula 3:

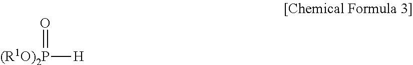

with phosphorous chloride to provide a compound represented by the following Chemical Formula 4:

(R¹O)₂PCl; [Chemical Formula 4]
and reacting an amine compound represented by the following Chemical Formula 5:

R²R³NH [Chemical Formula 5]
with the compound represented by Chemical Formula 4 to provide the phosphorous containing compound represented by Chemical Formula 1.

In some embodiments, the reacting of the compound represented by Chemical Formula 3 with phosphorus chloride is in chlorinated solvent. In some embodiments, the reacting of the amine compound represented by Chemical Formula 5 with the compound represented by Chemical Formula 4, is in chlorinated solvent.

In some embodiments, the phosphorus chloride includes phosphorus pentachloride (PCl₅), phosphorus trichloride (PCl₃), or the like.

In some embodiments, the chlorinated solvent includes dichloromethane (CH₂Cl₂), tetrachloromethane (CCl₄), chloroform (CHCl₃), or the like.

In some embodiments, the reacting of the compound represented by Chemical Formula 3 with phosphorous chloride is conducted for 1 to 24 hours and at a temperature of 25 to −78° C. to prepare the compound represented by Chemical Formula 4.

In some embodiments, in the reacting of the compound represented by Chemical Formula 3 with phosphorous chloride, a molar ratio of the compound represented by Chemical Formula 3 to the phosphorous chloride, is from 1:1 to 1:5.

In some embodiments, the reacting of the compound represented by Chemical Formula 4 with the amine compound represented by Chemical Formula 5 is for 2 to 24 hours. That is, in some embodiments, a phosphonate compound is reacted with phosphorous chloride in chlorinated solvent to prepare a chlorophosphite compound, and chlorophosphite compound is reacted with an amine compound in chlorinated solvent for 2 to 24 hours and at a temperature of 25 to −78° C. to prepare a phosphorus containing compound represented by Chemical Formula 1.

In some embodiments, in the reacting of the compound represented by Chemical Formula 4 with the amine compound represented by Chemical Formula 5, a molar ratio of the amine compound represented by Chemical Formula 5 to the compound represented by Chemical Formula 4, is from 2:1 to 4:1.

In some embodiments, the compound represented by Chemical Formula 3 is

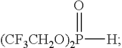

and the compound represented by Chemical Formula 4 is (CF₃CH₂O)₂PCl.

In some embodiments, the amine compound represented by Chemical Formula 5 is NH(CH₃)₂ and the phosphorous containing compound represented by Chemical Formula 1 is

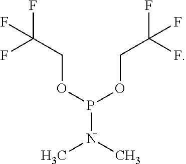 [SMILES: CN(C)P(OCC(F)(F)F)OCC(F)(F)F]

That is, in one embodiment, a phosphorus containing compound represented by Chemical Formula 2 is synthesized according to the following reaction scheme 1:

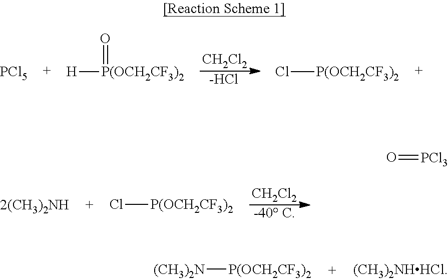

According to a further embodiment of the present disclosure, the phosphorus containing compound represented by Chemical Formula 1 is used as an additive in an electrolyte for a rechargeable lithium battery.

Specifically, in one embodiment, the electrolyte for a rechargeable lithium battery includes a lithium salt, a non-aqueous organic solvent, and an additive.

In one embodiment, the additive is the phosphorus containing compound represented by Chemical Formula 1. The phosphorus containing compound has a HOMO (highest occupied molecular orbital) energy level, which increased by unshared electron pairs in the nitrogen atom of the amine group in addition to the electron-donating characteristics of R² and R³ substituents as shown in Chemical Formula 1 and thus, in some embodiments, easily transports electrons to a positive electrode. Accordingly, when the phosphorus containing compound is used as an electrolyte additive for a rechargeable lithium battery, the phosphorus containing compound can be oxidized on the surface of the positive electrode for the rechargeable lithium battery during charging and thus, in some embodiments, forms a protective layer such as an SEI (a solid electrolyte interface) thereon, which in some embodiments, provides a rechargeable lithium battery with excellent cycle-life and high rate charge and discharge characteristics at a high voltage and/or a high temperature.

In some embodiments, the phosphorus containing compound is included in the electrolyte in an amount of from 0.01 to 10 wt % based on a total amount of the electrolyte. In some embodiments, the phosphorus containing compound is included in an amount of from 0.1 to 5 wt % based on a total amount of the electrolyte. In some embodiments, when the phosphorus containing compound is included in the electrolyte within these ranges, a layer is formed, which is stable at a high voltage and thus, a cycle-life characteristic of a rechargeable lithium battery in some of these embodiments is improved.

In some embodiments, the lithium salt is dissolved in an organic solvent, which supplies a battery with lithium ions, operates the rechargeable lithium battery, and improves transportation of the lithium ions between positive and negative electrodes.

Specific examples of the lithium salt include but are not limited to LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are non-zero natural numbers), LiCl, Lil, LiB(C₂O₄)₂ (lithium bis(oxalato)borate; LiBOB), or a combination thereof.

In one embodiment, the lithium salt is used in a concentration ranging from about 0.1 M to about 2.0 M. According to some embodiments, when the lithium salt is included within the above concentration range, an electrolyte has desired electrolyte conductivity and viscosity and thus has enhanced performance and effective lithium ion mobility.

According to some embodiments, the non-aqueous organic solvent serves as a medium of transmitting ions taking part in the electrochemical reaction of the battery. In some embodiments, the non-aqueous organic solvent is selected from at least one of a carbonate-based, ester-based, ether-based, ketone-based, alcohol-based, or aprotic solvent.

In some embodiments, the carbonate-based solvent includes, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and the like.

Particularly, in embodiments where a linear carbonate compound and a cyclic carbonate compound are mixed, a solvent having a high dielectric constant and low viscosity is provided. In some embodiments, the cyclic carbonate compound and the linear carbonate compound are mixed in a volume ratio of about 1:1 to about 1:9.

In some embodiments, the ester-based solvent includes methyl acetate, ethyl acetate, n-propyl acetate, dimethylacetate, methylpropionate, ethylpropionate, y butyrolactone, decanolide, valerolactone, mevalonolactone, caprolactone, and the like.

In some embodiments, the ether-based solvent includes dibutyl ether, tetraglyme, diglyme, dimethoxyethane, 2-methyltetrahydrofuran, tetrahydrofuran, and the like, and the ketone-based solvent may include cyclohexanone and the like. The alcohol-based solvent may include ethyl alcohol, isopropyl alcohol, and the like.

In some embodiments, the non-aqueous organic solvent is used singularly or in a mixture. In embodiments where the organic solvent is used in a mixture, the mixing ratio can be controlled in accordance with desirable battery performance.

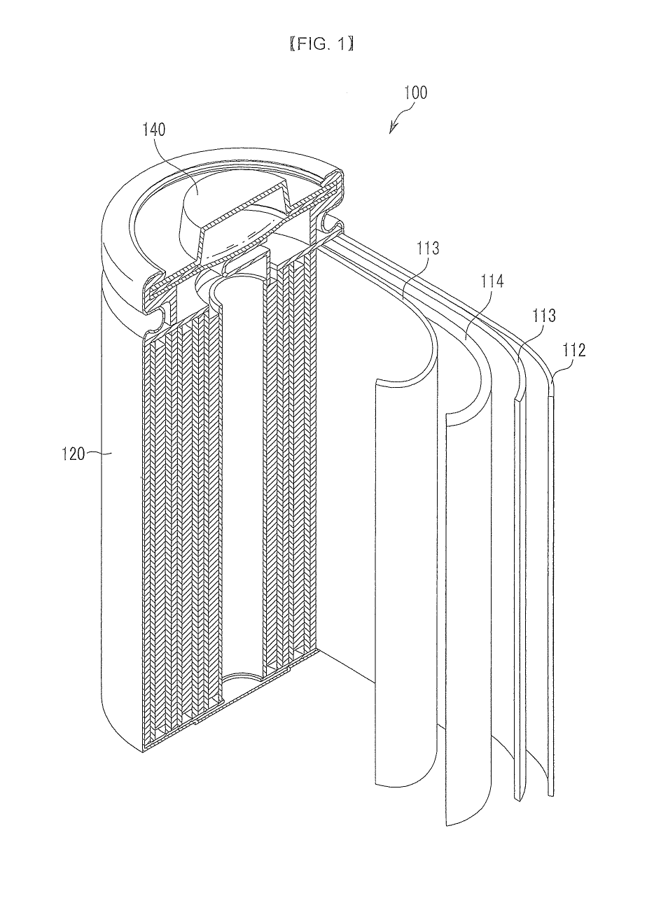

Hereinafter, a rechargeable lithium battery including the electrolyte is described referring to FIG. 1.

FIG. 1 is a schematic view showing a rechargeable lithium battery according to one embodiment.

Referring to FIG. 1, the rechargeable lithium battery 100 includes an electrode assembly including a positive electrode 114, a negative electrode 112 facing the positive electrode 114, a separator 113 between the positive electrode 114 and negative electrode 112, and an electrolyte impregnated in the positive electrode 114, the negative electrode 112, and the separator 113, a battery case 20 housing the electrode assembly, and a sealing member 140 sealing the battery case.

In some embodiments, the positive electrode 114 includes a positive current collector and a positive active material layer on the positive current collector. In some embodiments, the positive active material layer includes a positive active material and a binder. In some embodiments, the positive active material layer further includes a conductive material.

In some embodiments, the positive current collector is made of Al (aluminum) but embodiments of the present disclosure are not limited thereto.

In some embodiments, the positive active material includes lithiated intercalation compounds that reversibly intercalate and deintercalate lithium ions. In some embodiments, the positive active material includes a composite oxide including at least one selected from the group consisting of cobalt, manganese, and nickel, as well as lithium. Specific examples of composite oxides include, but are not limited to the following lithium-containing compounds:

LiₐA_{1-b}B_{b}D₂ (wherein, in the above chemical formula, 0.90≦a≦1.8 and 0≦b≦0.5); LiₐE_{1-b}B_{b}O_{2-c}D_{c} (wherein, in the above chemical formula, 0.90≦a≦1.8, 0≦b≦0.5, 0≦c≦0.05); LiE_{2-b}B_{b}O_{4-c}D_{c} (wherein, in the above chemical formula, 0≦b≦0.5, 0≦c≦0.05); LiₐNi_{1-b-c}Co_{b}B_{c}D_{α} (wherein, in the above chemical formula, 0.90≦a≦1.8, 0≦b≦0.5, 0≦c≦0.05, 0<α≦2); LiₐNi_{1-b-c}Co_{b}B_{c}O_{2-α}F_{α} (wherein, in the above chemical formula, 0.90≦a≦1.8, 0≦b≦0.5, 0≦c≦0.05, 0<α<2); LiₐNi_{1-b-c}CO_{b}B_{c}O_{2-α} F₂ (wherein, in the above chemical formula, 0.90≦a≦1.8, 0≦b≦0.5, 0≦c≦0.05, 0<α<2); LiₐNi_{1-b-c}Mn_{b}B_{c}D_{α} (wherein, in the above chemical formula, 0.90≦a≦1.8, 0≦b≦0.5, 0≦c≦0.05, 0<α≦2); LiₐNi_{1-b-c}Mn_{b}B_{c}O_{2-α} F_{α} (wherein, in the above chemical formula, 0.90≦a≦1.8, 0≦b≦0.5, 0≦c≦0.05, 0<α<2); LiₐNi_{1-b-c}Mn_{b}B_{c}O_{2-α} F₂ (wherein, in the above chemical formula, 0.90≦a≦1.8, 0≦b≦0.5, 0≦c≦0.05, 0<α<2); LiₐNi_{b}E_{c}G_{d}O₂ (wherein, in the above chemical formula, 0.90≦a≦1.8, 0≦b≦0.9, 0≦c≦0.5, 0.001≦d≦0.1.); LiₐNi_{b}Co_{c}Mn_{d}GₑO₂ (wherein, in the above chemical formula, 0.90≦a≦1.8, 0≦b≦0.9, 0≦c≦0.5, 0≦d≦0.5, 0.001≦e≦0.1.); LiₐNiG_{b}O₂ (wherein, in the above chemical formula, 0.90≦a≦1.8, 0.001≦b≦0.1.); LiₐCₒG_{b}O₂ (wherein, in the above chemical formula, 0.90≦a≦1.8, 0.001≦b≦0.1.); LiₐMnG_{b}O₂ (wherein, in the above chemical formula, 0.90≦a≦1.8, 0.001≦b≦0.1.); LiₐMn₂G_{b}O₄ (wherein, in the above chemical formula, 0.90≦a≦1.8, 0.001≦b≦0.1.); QO₂; QS₂; LiQS₂; V₂O₅; LiV₂O₅; LilO₂; LiNiVO₄; Li_{(3-f)}J₂(PO₄)₃(0≦f≦2); Li^{(3-f)}Fe₂(PO₄)₃(0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

In some embodiments, the positive active material layer includes the positive active material with the coating layer thereon, or a combination of the active material and the active material coated with the coating layer. In some embodiments, the coating layer includes at least one coating element compound selected from the group consisting of an oxide and a hydroxide of the coating element, an oxyhydroxide of the coating element, an oxycarbonate of the coating element, and a hydroxycarbonate of the coating element. In some embodiments, the compound for the coating layer is either amorphous or crystalline. In some embodiments, the coating element included in the coating layer is selected from Mg, Al, Co, K, Na, Ca, Si, Ti, V, Sn, Ge, Ga, B, As, Zr, and a mixture thereof. In some embodiments, the coating process includes any suitable processes, which avoids or substantially avoids side effects on properties of the positive active material (e.g., spray coating, immersing), which is known to those having ordinary skill in the art.

In some embodiments, the binder improves binding properties of the positive active material particles to one another and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

In some embodiments, the conductive material improves electrical conductivity of a negative electrode. Any electrically conductive material which avoids or substantially avoids causing a chemical change can be used. Examples of the conductive material include, but are not limited to one or more of natural graphite, artificial graphite, carbon black, acetylene black, ketjen black, a carbon fiber, a metal powder or a metal fiber (e.g. of copper, nickel, aluminum, silver, and the like), and a polyphenylene derivative.

In some embodiments, a method of manufacturing the positive electrode 114 includes mixing an active material, a conductive material, and a binder into an active material composition, and coating the composition onto a current collector. In some embodiments, the solvent is N-methylpyrrolidone, but embodiments of the present disclosure are not limited thereto.

In some embodiments, the negative electrode 112 includes a negative current collector and a negative active material layer disposed thereon.

In some embodiments, the negative current collector includes a copper foil.

In some embodiments, the negative active material layer includes a negative active material and a binder. In some embodiments, the negative active material layer further includes a conductive material.

In some embodiments, the negative active material includes a material that reversibly intercalates/deintercalates lithium ions, a lithium metal, a lithium metal alloy, a material being capable of doping/dedoping lithium, or a transition metal oxide.

The material that can reversibly intercalate/deintercalate lithium ions includes, for example, a carbon material. In some embodiments, the carbon material is any suitable carbon-based negative active material in a lithium ion rechargeable battery. Examples of the carbon material include but are not limited to crystalline carbon, amorphous carbon, and mixtures thereof. In some embodiments, the crystalline carbon is non-shaped, or sheet, flake, spherical, or fiber shaped natural or artificial graphite. In some embodiments, the amorphous carbon is a soft carbon, a hard carbon, a mesophase pitch carbonization product, fired coke, or the like.

Examples of the lithium metal alloy include, but are not limited to lithium and a metal selected from Na, K, Rb, Cs, Fr, Be, Mg, Ca, Sr, Si, Sb, Pb, In, Zn, Ba, Ra, Ge, Al, and Sn.

In some embodiments, the material being capable of doping/dedoping lithium includes Si, SiOₓ (0<x<2), a Si—C composite, a Si-Q alloy (wherein Q is selected from an alkali metal, an alkaline-earth metal, a Group 13 to Group 16 element (excluding Si), a transition element, a rare earth element, and a combination thereof), Sn, SnO₂, a Sn—C composite, a Sn—R alloy (wherein R is selected from an alkali metal, an alkaline-earth metal, a Group 13 to Group 16 element (excluding Sn), a transition element, a rare earth element, and a combination thereof), and the like. In some embodiments, at least one of these materials may be mixed with SiO₂. In some embodiments, elements Q and R are each selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

In some embodiments, the transition element oxides include, but are not limited to vanadium oxide, lithium vanadium oxide, and the like.

According to some embodiments, the binder improves binding properties of negative active material particles with one another and with a current collector. Examples of the binder include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

In some embodiments, the conductive material is included to improve electrode conductivity. Any electrically conductive material which avoids or substantially avoids causing a chemical change can be used. Examples of the conductive materials include, but are not limited to carbon-based materials such as natural graphite, artificial graphite, carbon black, acetylene black, ketjen black, carbon fibers, and the like; metal-based materials of metal powder or metal fiber (e.g. including copper, nickel, aluminum, silver, and the like); conductive polymers such as polyphenylene derivatives; and mixtures thereof.

In some embodiments, a method of manufacturing the negative electrode 112 includes mixing a negative active material, a conductive material, and a binder into a negative active material composition, and coating the composition onto a current collector. In some embodiments, the solvent is N-methylpyrrolidone but embodiments of the present disclosure are not limited thereto.

In some embodiments, the separator 113 includes one or more materials suitable for use in a lithium battery, as long as it separates the negative electrode 112 from the positive electrode 114 and provides a transporting passage for lithium ions. In other words, according to embodiments of the present disclosure, the separator has a low resistance to ion transportation and good impregnation for an electrolyte. For example, the separator can be made of a material selected from fiberglass, polyester, polyethylene, polypropylene, polytetrafluoroethylene (PTFE), and a combination thereof, and can be a non-woven fabric or a woven fabric. For example, for a lithium ion battery, a polyolefin-based polymer separator such as polyethylene, polypropylene or the like can be used. In some embodiments, a coated separator including a ceramic component or a polymer material is used, which in some embodiments, ensures heat resistance and/or mechanical strength. In some embodiments, the separator is a single layer and in other embodiments the separator is multi-layered.

Hereinafter, the embodiments are illustrated in more detail with reference to examples. These examples, however, should not in any sense be interpreted as limiting the scope of the present invention.

### Preparation Example 1

### Preparation of Phosphorus Containing Compound

19.36 g (78.5 mmol) of bis(2,2,2-trifluoroethyl)phosphonate and 60 mL of CH₂Cl₂ were put in a three-necked flask having a thermometer and a reflux cooler, and the mixture was cooled down to −78° C. Next, a solution which was prepared by dissolving 18.0 g (86.4 mmol) of PCl₅ in 60 mL of CH₂Cl₂ was added to the cooled mixture for one hour in a dropwise fashion for one hour and was then agitated. HCl gas was produced during the reaction. The mixture was additionally mixed at the same temperature of −78° C. for 2 hours and then, at room temperature for one hour. HCl gas was removed by passing argon (Ar) gas, obtaining bis(2,2,2-trifluoroethyl)chlorophosphite. The mixture was analyzed by ³¹P NMR. As a result, two signals of 166.31 ppm corresponding to the bis(2,2,2-trifluoroethyl)chlorophosphite and 4.70 ppm corresponding to O═PCl₃ were found therein.

Then, the bis(2,2,2-trifluoroethyl)chlorophosphite was dissolved in 120 mL of CH₂Cl₂, and a solution which was prepared by dissolving 21.2 g (471 mmol) of dimethylamine in 120 mL of CH₂Cl₂ was added thereto. The mixture was maintained at −40° C. for one hour. A white precipitate of dimethylammonium hydrochloride was produced therein. The mixture was additionally mixed at −20° C. for 1 hour and then, for 1 hour at room temperature. Then, HCl gas produced therein was removed by passing argon (Ar) gas for 30 minutes. The dimethylammonium hydrochloride was filtered to remove the CH₂Cl₂ solvent under a reduced pressure, obtaining 2.1 g of bis(2,2,2-trifluoroethyl)dimethylamido-phosphite. The product was obtained in a yield of 15% and purity of 99%.

The bis(2,2,2-trifluoroethyl)dimethylamidophosphite was a transparent colorless liquid compound represented by the following Chemical Formula 2 having a boiling point of 25° C. (1 mmHg), density (d4²⁰) of 1.2295, polarization characteristic (nD²⁰) of 1.3823, and viscosity of 3.839 cP and was soluble in an organic solvent.

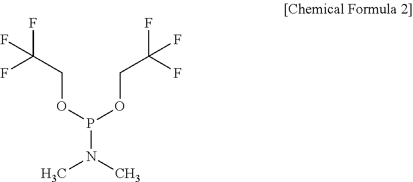 [SMILES: CN(C)P(OCC(F)(F)F)OCC(F)(F)F]

In addition, the bis(2,2,2-trifluoroethyl)dimethylamidophosphite was analyzed by ¹H NMR, ¹³C NMR, ¹⁹F NMR, and ³¹P NMR. The results are as follows.

¹H NMR (CDCl₃, d, ppm): 2.64 d (6H, NCH3, ³J_{HCNP} 9.2 Hz); 3.98 qn (2H, OCH₂, ³J_{HF}=³J_{HCOP} 8.7 Hz); 3.98 qn (2H, CF3CH2O, ³J_{HF}=³J_{HCOP} 8.4 Hz)

¹³C NMR (CDCl₃, d, ppm): 34.26 dd (CH3N, ²J_{CNP} 20.4 Hz, ²J_{CNP} 1.2 Hz); 61.31 qd (CF₃CH₂O, ²J_{CF} 36.4 Hz, ²J_{POC} 15.7 Hz); 123.73 qd (CF₃CH₂O, ¹J_{CF} 278.1 Hz, ³J_{CCOP} 7.7 Hz)

¹⁹F NMR (CDCl₃, d, ppm): −75.4 td (CF₃, ³J_{HF} 8.4 Hz, ⁴J_{PF} 4.9 Hz)

³¹P NMR (CDCl₃, d, ppm): 50.80 heptet (⁴J_{PF} 4.9 Hz)

Furthermore, the bis(2,2,2-trifluoroethyl)dimethylamidophosphite was analyzed by IR. The result is provided as follows.

IR (film, cm⁻¹): 2934, 2894, 2852, 2807, 1689, 1487, 1455, 1416, 1278, 1282, 1165, 1103, 1072, 980, 964, 847, 796, 747, 700, 656, 563, 552, 536, 483, 442, 407.

In addition, the bis(2,2,2-trifluoroethyl)dimethylamidophosphite included elements in the following amounts. The following “Found” was measured with elemental analysis equipment, and the following “Calcd” was obtained through molecular calculation:

Found, %: C, 26.08; H, 3.31; F, 41.53; P, 11.50. C₆H₁₀F₆NO₂P

Calcd, %: C, 26.39; H, 3.69; F, 41.74; P, 11.34.

### Preparation of Electrolyte for Rechargeable Lithium Battery

### Example 1

An electrolyte was prepared by mixing ethylene carbonate (EC), ethylmethyl carbonate (EMC), and dimethyl carbonate (DMC) in a volume ratio of 3:4:3 to prepare a solvent, dissolving 1.3M LiPF₆ therein, and adding the phosphorous containing compound according to Preparation Example 1. The phosphorous containing compound was added in an amount of 2.28 wt % based on a total amount of the electrolyte.

A composition for a positive active material layer was prepared by mixing LiNi_{0.75}Mn_{0.10}Co_{0.15}O₂, polyvinylidene fluoride (PVdF), and denka black in a weight ratio of 94:3:3 and dispersing the mixture in N-methyl-2-pyrrolidone. The composition was coated on a 20 μm-thick aluminum foil and then dried and compressed, to fabricate a positive electrode.

A composition for a negative active material layer was prepared by mixing graphite and styrene-butadiene rubber/carboxylmethyl cellulose (SBR/CMC) in a weight ratio of 97:3 and dispersing the mixture in water. The composition was coated on a 15 μm-thick copper foil and then, dried and compressed, to fabricate a negative electrode.

The positive electrode, the negative electrode, the electrolyte, and a separator formed of a polyethylene material, were used to fabricate a coin cell.

### Comparative Example 1

A coin cell was fabricated according to the same method as Example 1, except that an electrolyte was prepared by mixing ethylene carbonate (EC), ethylmethyl carbonate (EMC,) and dimethyl carbonate (DMC) in a volume ratio of 3:4:3 to prepare a solvent and dissolving 1.3M LiPF₆ therein.

### Evaluation 1: LSV (Linear Sweep Voltametry) Analysis of Electrolyte

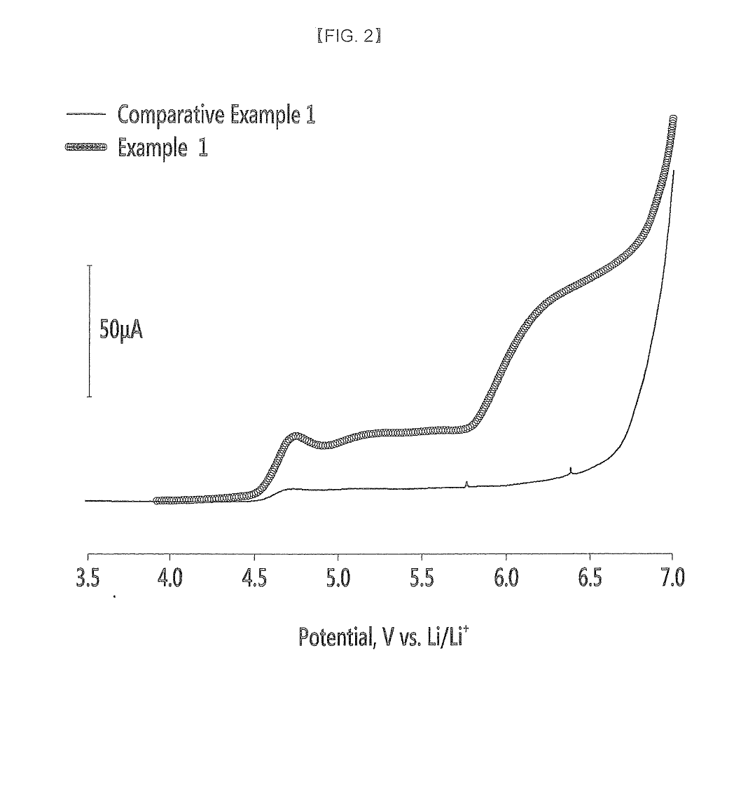

Anodic polarization measurements were obtained for the electrolytes according to Example 1 and Comparative Example 1 in order to evaluate oxidation electrode decomposition using LSV (linear sweep voltametry). The results are provided in FIG. 2. The measurements were performed using a three-electrode electrochemical cell including a Pt disk (having an inner diameter of 1.6 mm) as a work electrode, a Pt wire as a counter electrode, and a Li/Li⁺ as a reference electrode. The anodic polarization was performed at a scanning seed of 25 mV/sec.

FIG. 2 shows the LSV (linear sweep voltametry) graph of the electrolyte for a rechargeable lithium battery according to Example 1 and Comparative Example 1.

Referring to FIG. 2, the phosphorus-containing compound as an additive included in the electrolyte according to Example 1 was decomposed at a low potential during the anodic polarization. In other words, the phosphorus containing compound according to Example 1 was decomposed at a lower potential than the electrolyte including no phosphorus containing compound according to Comparative Example 1, due to a dimethylamino group working as an electron donor in Example 1.

### Evaluation 2: Cycle-Life Characteristic and High-Rate Charge and Discharge Characteristics at High Temperature of the Rechargeable Lithium Battery Cell

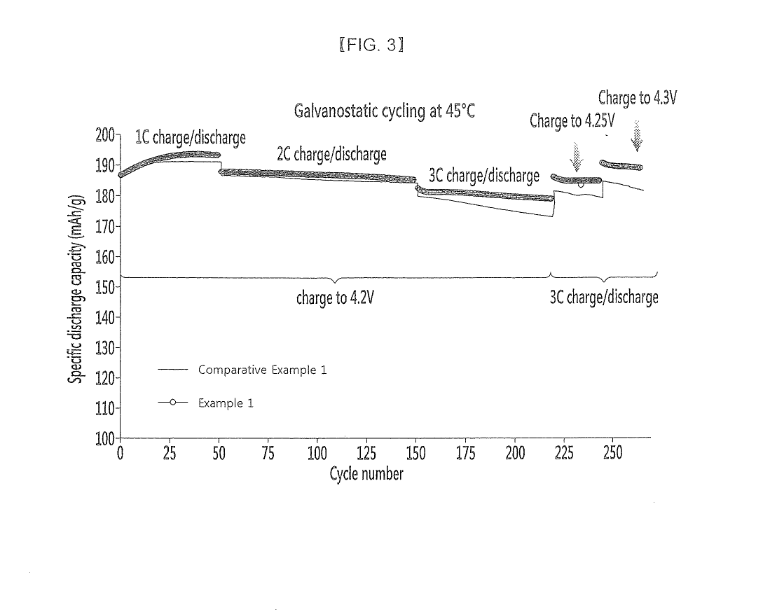

The rechargeable lithium battery cells according to Example 1 and Comparative Example 1 were charged and discharged at 45° C. under the following conditions and then, the cycle-life characteristic and high-rate charge and discharge characteristics were evaluated. The results are provided in FIG. 3.

The formation of the rechargeable lithium battery cells were performed at 0.2 C in a range of 2.8V to 4.2V. Then, the rechargeable lithium battery cells were charged and discharged for several cycles at 1 C in a range of 2.8V to 4.2V. Then, the rechargeable lithium battery cells were charged and discharged for several cycles at 2 C in a range of 2.8V to 4.2V. Then, the rechargeable lithium battery cells were charged and discharged for several cycles at 3 C in a range of 2.8V to 4.2V. Then, the rechargeable lithium battery cells were charged and discharged for several cycles at 3 C in a range of 2.8V to 4.25V. Then, the rechargeable lithium battery cells were charged and discharged for several cycles at 3 C in a range of 2.8V to 4.3V.

FIG. 3 is a graph showing capacities of the rechargeable lithium battery cells according to Example 1 and Comparative Example 1 as a function of cycle.

Referring to FIG. 3, the rechargeable lithium battery cell using a phosphorus containing compound represented by Chemical Formula 1 as an electrolyte additive according to Example 1 had smaller capacity change during the charge and discharge cycles at the same voltage and same current than the one including no phosphorus containing compound according to Comparative Example 1 and thus, excellent cycle-life characteristic at a high temperature. In addition, the rechargeable lithium battery cell according to Example 1 had a smaller capacity change at a higher rate and thus, excellent high-rate charge and discharge characteristics at a high temperature. In addition, the rechargeable lithium battery cell according to Example 1 had excellent cycle-life characteristic at high voltage and high rate compared with that according to Comparative Example 1.

### Example 2

An electrolyte was prepared by mixing ethylene carbonate (EC), ethylmethyl carbonate (EMC), and dimethyl carbonate (DMC) in a volume ratio of 3:4:3 to prepare a solvent, dissolving 1.15M LiPF₆ therein, and adding the phosphorous containing compound according to Preparation Example 1. The phosphorous containing compound was added in an amount of 0.11 wt % based on a total amount of the electrolyte.

A composition for a positive active material layer was prepared by mixing LiNi_{0.85}Mn_{0.05}Co_{0.10}O₂, polyvinylidene fluoride (PVdF), and denka black in a weight ratio of 94:3:3 and dispersing the mixture in N-methyl-2-pyrrolidone. The composition was coated on a 20 μm-thick aluminum foil and then dried and compressed, to fabricate a positive electrode.

A composition for a negative active material layer was prepared by mixing graphite and styrene-butadiene rubber/carboxylmethyl cellulose (SBR/CMC) in a weight ratio of 97:3 and dispersing the mixture in water. The composition was coated on a 15 μm-thick copper foil and then, dried and compressed, to fabricate a negative electrode.

The positive electrode, the negative electrode, the electrolyte, and a separator formed of a polyethylene material, were used to fabricate a coin cell.

### Example 3

A coin cell was fabricated according to the same method as Example 2, except that the phosphorous containing compound was added in an amount of 0.23 wt % based on a total amount of the electrolyte in preparation of the electrolyte.

### Example 4

A coin cell was fabricated according to the same method as Example 2, except that the phosphorous containing compound was added in an amount of 0.46 wt % based on a total amount of the electrolyte in preparation of the electrolyte.

### Comparative Example 2

A coin cell was fabricated according to the same method as Example 2, except that an electrolyte was prepared by mixing ethylene carbonate (EC), ethylmethyl carbonate (EMC,) and dimethyl carbonate (DMC) in a volume ratio of 3:4:3 to prepare a solvent and dissolving 1.15M LiPF₆ therein.

### Evaluation 3: High-Rate Charge and Discharge Characteristics the Rechargeable Lithium Battery Cell

The rechargeable lithium battery cells according to Examples 2 to 4 and Comparative Example 2 were charged and discharged at 25° C. under the following conditions and then, the high-rate charge and discharge characteristics were evaluated. The results are provided in Table 1.

The rechargeable lithium battery cells were charged at 0.2 C and discharged at 0.2 C in a range of 2.8V to 4.2V. Then, the rechargeable lithium battery cells were charged at 0.2 C and discharged at 0.2 C in a range of 2.8V to 4.2V (0.2 C/0.2 D). Then, the rechargeable lithium battery cells were charged at 0.2 C and discharged at 1 C in a range of 2.8V to 4.2V (0.2 C/1 D). Then, the rechargeable lithium battery cells were charged at 0.2 C and discharged at 3 C in a range of 2.8V to 4.2V (0.2 C/3 D). Then, the rechargeable lithium battery cells were charged at 0.2 C and discharged at 5 C in a range of 2.8V to 4.2V (0.2 C/5 D).

TABLE 1

| | Specific discharge capacity (mAh/g) | | | |
|---|---|---|---|---|
| | 0.2 C/0.2 D | 0.2 C/1 D | 0.2 C/3 D | 0.2 C/5 D |
| Example 2 | 205 | 187 | 174 | 151 |
| Example 3 | 203 | 185 | 175 | 153 |
| Example 4 | 205 | 185 | 175 | 154 |
| Comparative | 203 | 182 | 170 | 141 |
| Example 2 | | | | |

Referring to Table 1, the rechargeable lithium battery cell using a phosphorus containing compound represented by Chemical Formula 1 as an electrolyte additive according to Examples 2 to 4 had excellent high-rate charge and discharge characteristics at a high voltage compared with that including no phosphorus containing compound according to Comparative Example 2.

While this disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

### DESCRIPTION OF SYMBOLS

100: rechargeable lithium battery
112: negative electrode
113: separator
114: positive electrode
120: battery case
140: sealing member

What is claimed is:

1. A phosphorous containing compound represented by the following Chemical Formula 1:
(R¹O)₂P(NR²R³) [Chemical Formula 1]
wherein:
R¹ to R³ are each independently selected from hydrogen, a substituted or unsubstituted C1 to C20 alkyl group, a substituted or unsubstituted C1 to C20 haloalkyl group, a substituted or unsubstituted C2 to C20 alkenyl group, a substituted or unsubstituted C2 to C20 haloalkenyl group, a substituted or unsubstituted C2 to C20 alkynyl group, a substituted or unsubstituted C2 to C20 haloalkynyl group, a substituted or unsubstituted C1 to C20 alkoxy group, a substituted or unsubstituted C1 to C20 haloalkoxy group, a substituted or unsubstituted C6 to C30 aryl group, a substituted or unsubstituted C6 to C30 haloaryl group, —C—O—R⁴, and —O—C—O—R⁵;
each of two R¹ is the same or different from each other;
R⁴ and R⁵ are each independently selected from a substituted or unsubstituted C1 to C20 alkyl group, a substituted or unsubstituted C1 to C20 haloalkyl group, a substituted or unsubstituted C6 to C30 aryl group, and a substituted or unsubstituted C6 to C30 haloaryl group.

2. The phosphorous containing compound according to claim 1, wherein at least one of R¹ to R³ is selected from the substituted or unsubstituted C1 to C20 haloalkyl group, the substituted or unsubstituted C2 to C20 haloalkenyl group, the substituted or unsubstituted C2 to C20 haloalkynyl group, the substituted or unsubstituted C1 to C20 haloalkoxy group, and the substituted or unsubstituted C6 to C30 haloaryl group.

3. The phosphorous containing compound according to claim 1, wherein at least one of R¹ to R³ is selected from a substituted or unsubstituted C1 to C20 fluoroalkyl group, a substituted or unsubstituted C2 to C20 fluoroalkenyl group, a substituted or unsubstituted C2 to C20 fluoroalkynyl group, a substituted or unsubstituted C1 to C20 fluoroalkoxy group, and a substituted or unsubstituted C6 to C30 fluoroaryl group.

4. The phosphorous containing compound according to claim 1, wherein at least one of R¹ to R³ is a substituted or unsubstituted C1 to C20 fluoroalkyl group.

5. The phosphorous containing compound according to claim 1, wherein the phosphorous containing compound is represented by the following Chemical Formula 2:

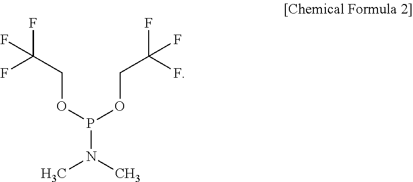 [SMILES: CN(C)P(OCC(F)(F)F)OCC(F)(F)F]

6. A rechargeable lithium battery electrolyte comprising the phosphorous containing compound according to claim 1.

7. The rechargeable lithium battery electrolyte according to claim 6, wherein the phosphorous containing compound is in an amount of from 0.1 to 5 wt % based on a total amount of the electrolyte.

8. The rechargeable lithium battery electrolyte according to claim 6, further comprising a lithium salt and a non-aqueous organic solvent.

9. A rechargeable lithium battery comprising the rechargeable lithium battery electrolyte according to claim 6.

10. The rechargeable lithium battery according to claim 9, wherein at least one of R¹ to R³ is selected from a substituted or unsubstituted C1 to C20 fluoroalkyl group, a substituted or unsubstituted C2 to C20 fluoroalkenyl group, a substituted or unsubstituted C2 to C20 fluoroalkynyl group, a substituted or unsubstituted C1 to C20 fluoroalkoxy group, and a substituted or unsubstituted C6 to C30 fluoroaryl group.

11. The rechargeable lithium battery according to claim 9, wherein at least one of R¹ to R³ is a substituted or unsubstituted C1 to C20 fluoroalkyl group.

12. The rechargeable lithium battery according to claim 9, wherein the phosphorous containing compound is represented by the following Chemical Formula 2:

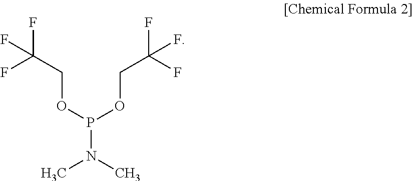 [SMILES: CN(C)P(OCC(F)(F)F)OCC(F)(F)F]

13. A method of preparing the phosphorous containing compound according to claim 1, the method comprising:
reacting a compound represented by the following Chemical Formula 3: 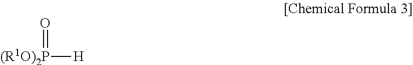
with phosphorous chloride to provide a compound represented by the following Chemical Formula 4:
(R¹O)₂PCl; [Chemical Formula 4]
and
reacting an amine compound represented by the following Chemical Formula 5:
R²R³NH [Chemical Formula 5]
with the compound represented by Chemical Formula 4 to provide the phosphorous containing compound represented by Chemical Formula 1.

14. The method according to claim 13, wherein the reacting of the compound represented by Chemical Formula 3 with phosphorous chloride is in chlorinated solvent.

15. The method according to claim 13, wherein the reacting of the amine compound represented by Chemical Formula 5 with the compound represented by Chemical Formula 4, is in chlorinated solvent.

16. The method according to claim 13, wherein the reacting of the chlorophosphite compound represented by Chemical Formula 4 with the amine compound represented by Chemical Formula 5 is for 2 to 24 hours.

17. The method according to claim 13, wherein a molar ratio of the amine compound represented by Chemical Formula 5 to the compound represented by Chemical Formula 4, is from 2:1 to 4:1.

18. The method according to claim 13, wherein:
the compound represented by Chemical Formula 3 is 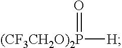
and
the compound represented by Chemical Formula 4 is (CF₃CH₂O)₂PCl.

19. The method according to claim 13, wherein:
the amine compound represented by Chemical Formula 5 is NH(CH₃)₂; and
the phosphorous containing compound represented by Chemical Formula 1 is 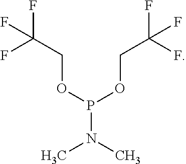 [SMILES: CN(C)P(OCC(F)(F)F)OCC(F)(F)F]
